(19) United States
(12) Patent Application Publication
(10) Pub. No.: US 2010/0304226 A1
(43) Pub. Date: Dec. 2, 2010

(54) MICROBIAL FUEL CELL

(75) Inventors: Jurg Keller, Chapel Hill Queensland (AU); Korneel Rabaey, Indooroopilly Queensland (AU); Stefano Fereguia, St. Lucia Queensland (AU); Bernadino Virdis, St. Lucia Queensland (AU)

Correspondence Address: KNOBBE MARTENS OLSON & BEAR LLP, 2040 MAIN STREET, FOURTEENTH FLOOR, IRVINE, CA, 92614, US

(73) Assignee: THE UNIVERSITY OF QUEENSLAND, ST. LUCIA (AU)

(21) Appl. No.: 12/531,458

(22) PCT Filed: Mar. 17, 2008
(86) PCT No.: PCT/AU2008/000381

§ 371 Date: Aug. 10, 2010

(51) Int. Cl. H01M 8/16

(52) U.S. Cl. 429/401

(57) ABSTRACT

A microbial fuel cell having a pathway for passage of effluent from the anode to the cathode is provided, in addition to an ion exchange membrane between the chambers. Effluent may also pass from cathode to anode forming a continuous loop. Oxidation of effluent at the anode creates ammonium ions and produces electrons for an external circuit. The ammonium ions undergo nitrification at the cathode. Alternatively a nitrification reactor may be provided in the effluent pathway. Electrons are received by the cathode from the external circuit to reduce nitrate ions created by the nitrification process.

### FIELD OF THE INVENTION

This invention relates to microbial fuel cells, and in particular to fuel cells in which effluent or other fluid containing organic and/or inorganic compounds is conveyed from an anode to a cathode along a fluid pathway. A separate nitrification process may be provided via a reactor in the pathway.

### BACKGROUND TO THE INVENTION

Microbial fuel cells offer a relatively new technology that removes organic compounds from wastewater and generates electricity. Energy produced by micro-organisms is captured for use outside the fuel cell. The fuel cells can therefore potentially reduce the operating cost of wastewater treatment plants by producing the power required to drive electrical equipment at the plant, such as pumps and fans. Conventional wastewater processes typically involve oxidation of the chemical oxygen demand (COD) directly to carbon dioxide by aerobic treatment, or production of methane by anaerobic digestion, but make no use of the energy which is released in these processes.

A conventional microbial fuel cell generally has two compartments, namely an anode chamber and a cathode chamber. In the anode chamber wastewater organics are oxidised to carbon dioxide simultaneously with transfer of electrons to an anode. In the cathode chamber, electrons are transferred from a cathode to an electron acceptor such as oxygen, ferricyanide or nitrate. Bacteria or catalysts are used to facilitate each process and create a potential difference which causes a flow of electrons from anode to cathode through an external pathway. The two chambers are separated by an ion exchange membrane, more specifically a proton exchange membrane (PEM). Positive ions produced in the anode chamber flow through the membrane to the cathode chamber. The external pathway includes a load which consumes power produced by the fuel cell.

TerHeijne and coworkers (terHeijne A, Hamelers H V M, deWilde V, Rozendal R A, Buisman C J N (2006) A Bipolar Membrane Combined with Ferric Iron Reduction as an Efficient Cathode System in Microbial Fuel Cells. Environ. Sci. Technol. 40: 5200-5205) used a bipolar membrane to facilitate proton supply to the cathode compartment of a MFC, where ferric iron was reduced at low pH levels.

Jang and coworkers (Jang J K, Pham T H, Chang I S, Kang K H, Moon H, Cho K S et al. (2004) Construction and operation of a novel mediator- and membrane-less microbial fuel cell. Process Biochemistry 39: 1007-1012.) constructed a single chamber upflow MFC, in which liquid from the anode flowed into the cathode, where aeration was foreseen, as also described in WO 03/096467 A1. This system suffered from oxygen reflux from cathode to anode, which was alleviated by inserting compounds such as glass wool between the compartments. However, the internal resistance of the system was substantial causing low performance.

Liu and Logan (Liu H, Logan B E (2004) Electricity generation using an air-cathode single chamber microbial fuel cell in the presence and absence of a proton exchange membrane. Environmental Science & Technology 38: 4040-4046.) omitted the membrane from a MFC in order to promote cation transport from anode to cathode. They achieved a higher performance in terms of power output in comparison to a membrane containing system but the crossover of reduced substrate from the anode to the cathode compartment caused efficiency decreases.

In Park, D. H., and J. G. Zeikus, 2003 “Improved fuel cell and electrode designs for producing electricity from microbial degradation”, Biotechnology and Bioengineering 81:348-355, a microbial fuel cell in which the membrane and cathode were assembled in a membrane electrode assembly (MEA) was presented. A kaolin clay layer functioned as membrane. This action decreased the amount of energy that was needed to operate the MFC, since aeration was no longer necessary. The construction of the MEA was complicated. This strategy does not solve cation diffusion limitations.

### SUMMARY OF THE INVENTION

It is an object of the invention to provide an improved microbial fuel cell or at least to provide an alternative to existing fuel cells.

In one aspect the invention resides in a microbial fuel cell for treatment of a fluid containing organic and/or inorganic compounds, including: a pathway along which the fluid passes for treatment, an anode located in the pathway and able to transfer electrons released from the organic or inorganic compounds to an external circuit, a cathode located in the pathway and able to transfer electrons from the external circuit to electron acceptors in the fluid, and a separator located between the anode and cathode and which allows flow of ions in the fluid from the anode to the cathode.

Preferably the pathway enables fluid to pass from the anode to the cathode. Preferably the pathway also enables fluid to pass from cathode to anode. In one embodiment the pathway forms a continuous loop including anode and cathode.

Preferably the pathway from anode to cathode includes a reactor for oxygenation or nitrification of the fluid. The cathode is also preferably aerated, oxygenated or is open to the air.

In a further aspect the invention resides in a method of treating a fluid in a microbial fuel cell, including: passing the fluid through an anode for biological oxidation processes, passing the fluid from the anode to a cathode, passing the fluid through the cathode for reduction processes, allowing passage of ions from the anode to the cathode through a separator, and developing a voltage between the anode and the cathode.

Preferably the method further includes passing the fluid from the cathode to the anode. Preferably the method also includes passing the fluid through a nitrification reactor between the anode and the cathode, and optionally also aerating or oxygenating the cathode.

The invention also resides in any alternative combination of features which are indicated in this specification. All known equivalents of these features are deemed to be included whether or not expressly set out.

### LIST OF FIGURES

Preferred embodiments of the invention will be described with respect to the accompany drawings in which:

FIG. 1 shows a microbial fuel cell having an effluent pathway between anode and cathode,

FIG. 2 shows a microbial fuel cell having an effluent pathway with a nitrification reactor, and

FIGS. 3, 4, 5, 6 show fuel cells having alternative effluent pathways.

### DESCRIPTION OF THE PREFERRED EMBODIMENTS

Referring to the drawings it will be appreciated that the invention may be implemented in various ways, using a range of different pathways for effluent. These embodiments are given by way of example only.

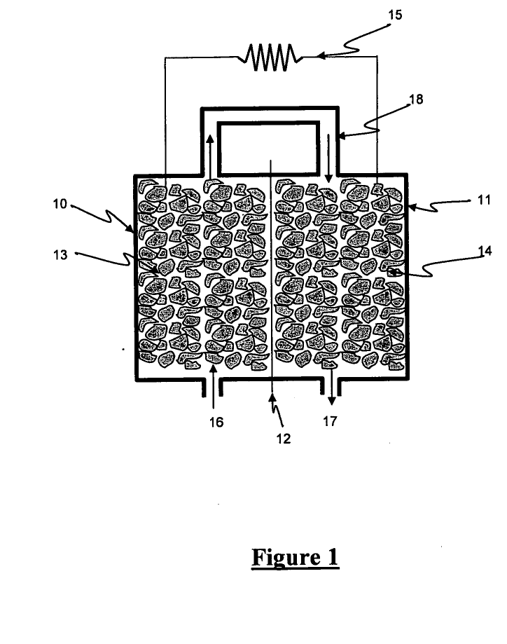

FIG. 1 schematically shows a microbial fuel cell having an anode chamber 10 and a cathode chamber 11, separated by an ion exchange membrane 12. The anode and cathode chambers include anodic and cathodic electrodes 13 and 14 respectively, connected through an external electrical pathway 15. An inlet 16 for effluent is provided in the anode chamber with an outlet 17 in the cathode chamber. An effluent pathway 18 forms a loop for flow of effluent from the anode to the cathode. The effluent forms a fuel for operation of the cell and is typically acidified wastewater. The effluent flows continuously into the cell through the anode chamber and out through the cathode chamber. Flow of effluent from the anode to the cathode enables pH control within the cell if required, particularly in relation to the cathode.

Organic substrates, sulphur and other reduced components of the effluent are oxidised in the anode chamber 10 while oxygen, nitrate or oxidised substrates are reduced in the cathode chamber 11, catalysed by the action of micro-organisms. The anode 13 and cathode 14 may be provided as a variety of different structures, so long as the micro-organisms are able to colonise the structures and effluent is able to flow freely throughout. The term “chamber” should therefore be interpreted in a broad sense to include the volume filled or defined by the porous anode and cathode structures, regardless of whether the anode or cathode are surrounded by solid boundaries. In some embodiments, the anode may be bounded only by the separator and the cathode may be open to the air for example. Micro-organisms can be present in either or both of the chambers, depending on the nature of the effluent and the chemical processes which are required. If both nitrate and organics in the effluent are to be treated then organisms are generally required in both chambers.

The electrodes can be any structure that provides a resistivity lower than about 5 ohm/cm, using typically carbon materials such as graphite. Examples of structures are felt, tape, brush, bottle brush shape and granular. The cathode is also preferably aerated or oxygenated through an inlet (not shown) to the cathode chamber, or the cathode is directly exposed to the air. The membrane 12 is cation selective, anion selective or a non-selective separator depending on the reactions in the anode chamber, and preferably creates an internal resistance of less than 50 ohms.

The loop 18 provides a pathway for ions and enables reuse of the effluent between anode and cathode, and also a degree of pH modification. Oxidation reactions in the anode chamber 10 produce ammonium ions which are able to move through the membrane 12 or are carried around the loop 18. Nitrification of the ammonium takes place in the cathode chamber 11 to produce nitrate or nitrite ions which are in turn reduced to nitrogen. The nitrate or nitrite ions act as an electron acceptor at the cathode. Electrons are released at a relatively high potential by oxidation in the anode chamber and flow from the anode 13 around the external circuit to the cathode 14. Power is delivered to a load in the electrical pathway 15. A liquid containing halogenated hydrocarbon may also be added to the effluent to provide an additional electron acceptor in the cathode chamber.

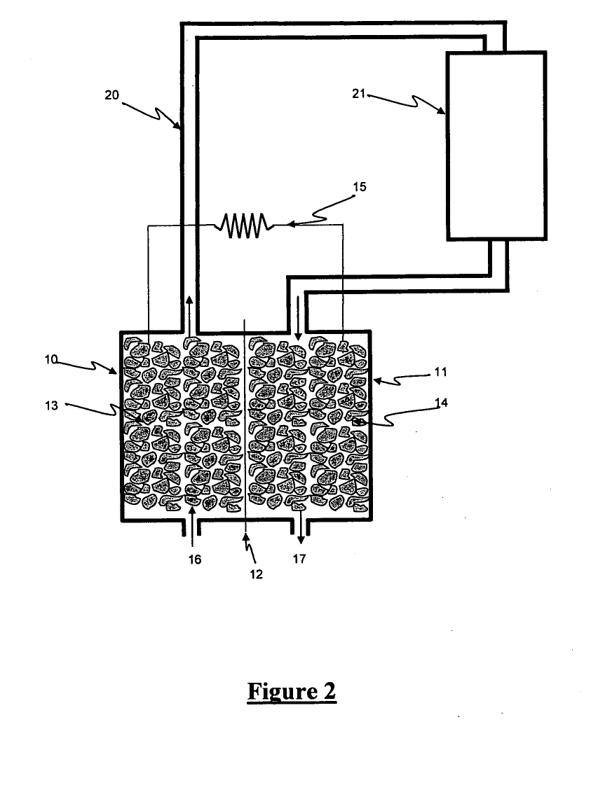

FIG. 2 shows how an intermediary treatment step may be included in the effluent pathway between the anode chamber and the cathode chamber. In this example an extended pathway 20 includes a separate nitrification reactor 21. The reactor stage may be provided in various forms, typically as a passively aerated bed containing micro-organisms. Effluent from the anode chamber is sprayed over the bed and allowed to trickle through to an exit connected to the cathode chamber. The micro-organisms oxidise ammonium in the effluent to form nitrate and nitrate ions, and to complete the oxidation of any remaining organic material.

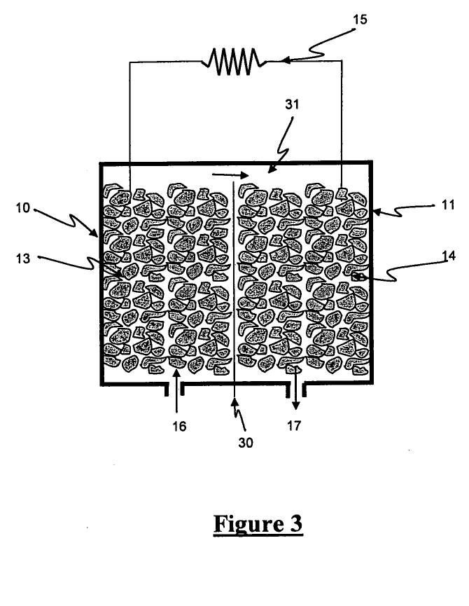

FIG. 3 shows an alternative microbial fuel cell in which the effluent pathway is provided as a direct flow from the anode chamber to the cathode chamber. In this example the membrane 30 does not extend fully across the cell creating a pathway 31 through which effluent simply overflows from one chamber to the other.

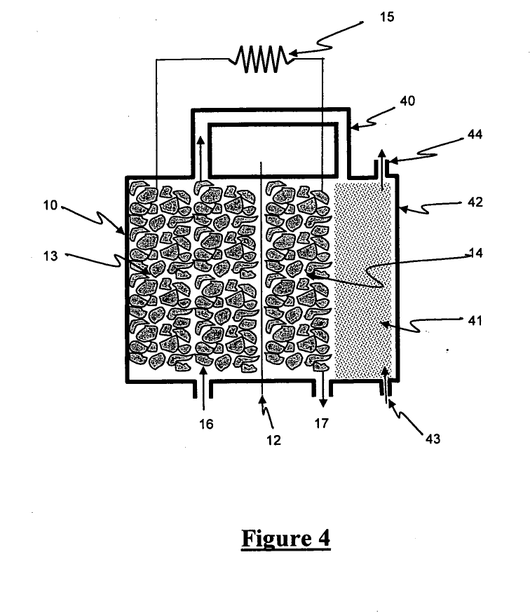

FIG. 4 shows a fuel cell with an alternative pathway including an intermediary treatment step. The pathway 40 supplies effluent into a nitrification reactor 41 which is formed as part of an extended cathode chamber 42. The reactor is aerated through inlet 43 and outlet 44. Alternatively the reactor can be open to the air without need of a forced flow. A variety of other loop structures are also possible for the effluent pathway.

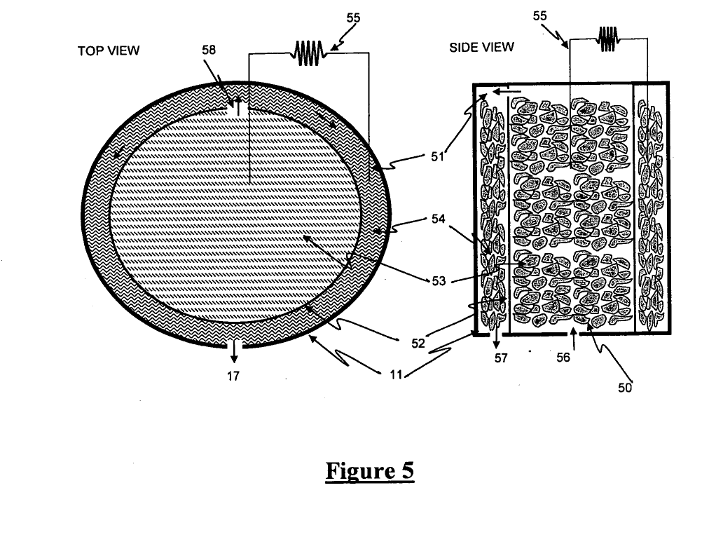

FIG. 5 shows a further alternative fuel cell having a circular configuration. The anode chamber 50 is cylindrical in this example and is surrounded by an annular cathode chamber 51. An ion exchange membrane 52 forms the outer wall of the anode chamber and also the inner wall of the cathode chamber. The cathode may be open to the air, as mentioned above, so that the cathode chamber is formed by the volume of the cathode itself. In commercial installations the cell may be several meters in height and surrounded by a protective structure such as wire netting. The anode 53 and cathode 54 are provided by a granular material and linked by an external current pathway 55. Effluent enters the anode through inlet 56 and leaves the cathode through outlet 57. An effluent pathway 58 is provided between the chambers as an aperture in the upper part of the membrane through which effluent overflows from one chamber to the next.

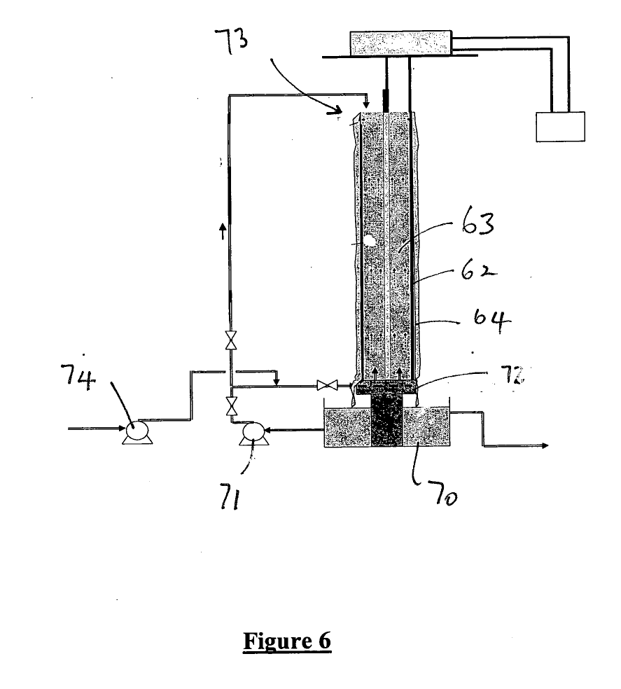

FIG. 6 shows a cell in which effluent is circulated along a continuous pathway from anode to cathode and back to anode, with fresh effluent being added when required. The anode 63 is provided in a central column surrounded by the cathode 64, and separated from the cathode by a membrane 62. Effluent passes upward through the anode and then overflows to pass downwards through the cathode into a sump 70. An arrangement of pumps, pipes and valves allows effluent to be supplied to the cell and/or circulated through the cell in several ways. A recirculation pump 71 transfers effluent from the sump 70 either to the base 72 of the anode, or to the top 73 of the anode. A feed pump 74 provides fresh effluent to the base of the anode when required. Effluent can also be drained from the sump when required. The cell in this example therefore contains a continuous pathway or loop through the anode and the cathode. A cell having a fluid pathway from anode to cathode, and preferably also from cathode to anode, can thereby be operated in a way which maintains pH in both the anode and the cathode at appropriate levels, depending on the nature of the effluent.

In a prototype cell based on FIG. 6 the anode and cathode were provided as carbon fibres, activated carbon cloth or activated carbon felt. The separator was a cation exchange membrane available under the trademark ULTREX. A modular system was constructed with 12 cells in series. Each cell was cylindrical with a height and diameter of approximately 300 cm and 18 cm respectively. A 30 W pump was required to urge the effluent upwards through the anode.

The invention is further explained with reference to the following examples.

### Example 1

In this example a microbial fuel cell was used to test the ability of the loop concept to perform COD polishing and effluent pH control at different loading rates while not losing performance in terms of current production. The microbial fuel cell comprised of an anode containing granular graphite (El Carb 100, Graphite Sales Inc, USA) supporting the growth of an anodophilic biofilm and a cathode of the same graphite supporting a cathodophilic biofilm, with oxygen provided with an air sparger. The cation exchange membrane (Ultrex, CMI-7000, Membranes International, USA) separated the two compartments and the anode effluent was used as cathode influent as shown in the loop connection. The external circuit was closed on a resistor of 10 Ohm.

The feed to the microbial fuel cell contained a medium with composition 6 g/L NaH₂PO₄, 3 g/L KH₂PO₄, 0.1 g/L NH₄Cl, 0.5 g/L NaCl, 0.1 g/L MgSO₄.7H₂O, 15 mg/L CaCl₂.2H₂O, 1.0 mL/L of a trace elements solution. The carbon source and electron donor was acetate with a concentration of 470 mg/L. The treated microbial fuel cell effluent exited by overflow from the cathode side. Two loading rates were tested (1.7 and 3.4 g_{COD} L⁻¹d⁻¹) by modifying the feed rate. Each loading rate was kept for 2 days (or 4 hydraulic retention times) in order to let the process reach steady state at the new conditions before sampling was undertaken.

The results are shown in Table 1. At both organic loading conditions the fuel cell is able to remove >98% of the incoming acetate while maintaining the effluent pH at a rather constant value. The current production was not impaired at the overloaded condition, which implies that the loop concept is able to handle sudden short term loading upsets without losing performance.

TABLE 1

| | | | High feed |
|---|---|---|---|
| Conditions | | Standard | rate |
| Acetate in | mg/L | 470 | 470 |
| Loading | g_{COD}/Ld | 1.7 | 3.4 |
| Acetate anode | mg/L | 118 | 224 |
| Acetate cathode | mg/L | 8 | 3 |
| Current | mA | 28.5 | 34.2 |
| Acetate removal | % | 98.4% | 99.4% |
| pH anode | | 6.2 | 6.6 |
| pH cathode | | 7.2 | 7.3 |

### Example 2

A microbial fuel cell was used to test the possibility of obtaining simultaneous carbon and nitrogen removal. The microbial fuel cell was made of two rectangular Perspex frames (dimensions 14×12×2 cm) placed side by side and held together by two equal Perspex square plates with threaded rods and wing nuts. The cation exchange membrane (Ultrex CMI-7000, Membranes International, USA) was placed in between the two compartments. Wet seal was ensured by rubber sheets inserted between every frame. Granular graphite with diameter ranging from 2 to 6 mm (El Carb 100, Graphite Sales, Inc., USA) was used as conductive material in both compartments.

The loop concept is applied as the liquid stream passes through the anode and then goes into an external aerobic stage which interposes in between the two anodic and cathodic stages and is then diverted again in the cathodic side of the microbial fuel cell. The aerobic stage consists of a trickling bed reactor where the liquid is sprayed on the top and the oxygenation is guaranteed throughout passive aeration during its percolation. The liquid is collected on the bottom of the reactor and it then constitutes the influent of the final cathodic compartment.

In this three step process, the synthetic wastewater (composition below) enters the anodic compartment where oxidation of carbon compounds occurs. The effluent of the anode (now containing mostly ammonia) is then diverted into the nitrification stage when specific heterotrophic biofilm achieved aerobic ammonia oxidation to nitrate and polish the wastewater from any carbonaceous left over from the previous stage. As final step, the now nitrate enriched liquid is fed into the cathode where autotrophic bacteria catalyse nitrate reduction to nitrogen gas using the electrode as the sole electron donor.

The feed to the microbial fuel cell contained a medium with composition 6 g/L NaH₂PO₄, 3 g/L KH₂PO₄, 0.347 g/L NH₄Cl, 0.5 g/L NaCl, 0.1 g/L MgSO₄.7H₂O, 15 mg/L CaCl₂.2H₂O, 1.0 mL/L of a trace elements solution. The carbon source and electron donor was acetate with a concentration of 245 mg/L. The flow rate used was 1.39 L d⁻¹, giving a loading rate of 2 g_{COD} L⁻¹d⁻¹.

Table 2 summarizes the results obtained at different applied resistances. High acetate removal is almost complete at all resistance as any left over is polished in the nitrification step. Denitrification is clearly the result of the current generated by the microbial fuel cell as the nitrate reduction is dependent on the electrons availability at the cathode.

TABLE 2

| Applied | | | Denitrification | | | |
|---|---|---|---|---|---|---|
| re- | Current | | efficiency at the | | Acetate removal | |
| sistance | mA | | cathode | | efficiency | |
| □ | Average | Std. Dev. | Average | Std. Dev. | Average | Std. Dev. |
| 5 | 25.1 | 4.8 | 98.2% | 0.6% | 99.2% | 0.4% |
| 10 | 23.2 | 3.5 | 97.9% | 1.5% | 99.3% | 0.4% |
| 20 | 18.0 | 1.7 | 86.1% | 10.9% | 98.7% | 0.9% |
| 50 | 9.0 | 0.0 | 39.1% | 3.7% | 99.1% | 0.2% |
| 100 | 4.8 | 0.1 | 19.0% | 0.6% | 98.9% | 0.5% |

### Example 3

In this example microbial fuel cells were constructed following the embodiment in FIG. 6. Pre-fermented wastewater from a brewery was used as influent for the anode. The microbial fuel cells were three meters high, diameter 0.20 m. The membrane around the anode (carbon fiber brushes) was ULTREX. The cathode consisted of carbon fiber brushes, attached to a stainless steel mesh. Wastewater was brought on the recirculation loop, first entered the anode where oxidation of the pollutants was achieved. The effluent of the anode was brought to the cathode, where oxygen reduction took place. The effluent of the cathode was captured in a sump, from where it entered the recirculation loop again. Effluent was discharged from the sump. When applying an external resistor of 0.4 Ω, a cell voltage of 0.6 Volts could be generated, implying a current of 1.5 A. This corresponds to a removal of 430 g of organics (expressed as chemical oxygen demand) per cubic metre anode volume per day from the wastewater.

1. A microbial fuel cell for treatment of a fluid containing organic and/or inorganic compounds, including:
a pathway along which the fluid passes for treatment,
an anode located in the pathway and able to transfer electrons released from the organic or inorganic compounds to an external circuit,
a cathode located in the pathway and able to transfer electrons from the external circuit to electron acceptors in the fluid, and
a separator located between the anode and cathode and which allows flow of ions in the fluid from the anode to the cathode.

2. A fuel cell according to claim 1 wherein the pathway enables fluid to pass from the anode to the cathode.

3. A fuel cell according to claim 1 wherein the pathway enable fluid to pass from cathode to anode.

4. A fuel cell according to claim 1 wherein the pathway forms a continuous loop including anode and cathode.

5. A fuel cell according to claim 1 wherein the pathway includes a reactor for oxygenation or nitrification of the fluid.

6. A fuel cell according to claim 1 wherein the anode and/or the cathode contain micro-organisms which catalyse the respective transfer of electrons.

7. A fuel cell according to claim 1 wherein the cathode is aerated, oxygenated or is open to the air.

8. A method of treating a fluid in a microbial fuel cell, including:
passing the fluid through an anode for biological oxidation processes,
passing the fluid from the anode to a cathode,
passing the fluid through the cathode for reduction processes,
allowing passage of ions from the anode to the cathode through a separator, and
developing a voltage between the anode and the cathode.

9. A method according to claim 8 further including:
passing the fluid from the cathode to the anode.

10. A method according to claim 8 further including:
passing the fluid through a nitrification reactor between the anode and the cathode.

11. A method according to claim 8 further including aerating or oxygenating the cathode.
